(19) United States
(12) Patent Application Publication
(10) Pub. No.: US 2025/0200637 A1
(43) Pub. Date: Jun. 19, 2025

(54) SYSTEM AND METHOD FOR CONTINUITY OF USER ENGAGEMENT ACROSS PLATFORMS

(71) Applicant: Datum Point Labs Inc., Jackson, WY (US)

(72) Inventors: PATRICK NUNALLY, San Diego, CA (US); MICHAEL ZACHARSKI, Pawling, NY (US)

(21) Appl. No.: 18/982,945

(22) Filed: Dec. 16, 2024

Related U.S. Application Data
(60) Provisional application No. 63/612,171, filed on Dec. 19, 2023.

(51) Int. Cl. G06Q 30/0601

(52) U.S. Cl. CPC G06Q 30/0631

(57) ABSTRACT

Embodiments described herein relate to systems and methods to provide continuity of user data, experience, and engagement across cross disconnected platforms. In some embodiments, provide continuity of user data, experience and engagement across cross disconnected platforms includes linking a user to a physical ingress point to the complex platforms and one or more browser indexed links associating the retrieval of an anonymous application with two co-located devices where all traversed platforms are made contiguous with regard to continuity of user data, experience, and engagement across cross disjointed platforms.

### CROSS-REFERENCED APPLICATIONS

This application claims priority to and benefit of U.S. Provisional Application No. 63/612,171 filed Dec. 19, 2023 and entitled “System and Method for Continuity of User Engagement Across Platforms,” which is incorporated by reference herein in its entirety.

### TECHNICAL FIELD

The embodiments relate generally to systems and methods for user engagement across platforms.

### BACKGROUND

Internet-based web services can be delivered through web sites on the World Wide Web (WWW). A web site is typically a set of related web pages served from a web domain. Web pages are often formatted using HyperText Markup Language (HTML), extensible HTML (XHTML), or using another language that can be processed by a web browser that is typically executed on a user's client device, such as a computer, tablet, phablet, smart phone, smart television, or other client device. A web site is generally hosted on a web server. The web server is typically accessible via a network, such as the Internet, through a web address, which is generally known as a Uniform Resource Indicator (URI) or a Uniform Resource Locator (URL).

For example, a web service can be delivered via a web site. In some cases, the web site can allow users to access content delivered via the web site using anonymous user access. Some web sites can allow or require that users login to access some or all of the content delivered via the web site (e.g., subscription access may be required to access certain content on the web site, such as for an online newspaper, an e-commerce shopping site, a social networking web site, a web-based email service, a file sharing web site, and/or other web services).

A web site can be a static web site which does not customize content delivered to different users of the web site (e.g., a static web site has web pages stored on a web server in the format that is sent to a client web browser).

A web site can alternately be dynamic or can include dynamic web pages. Generally, a dynamic web site can customize content delivered to different users of the web site e.g., a dynamic web site is one that can change or customize web content automatically).

Static and dynamic websites often use cookies to track user actions on their site and even across other sites. Websites track user history in order to improve their services.

An HTTP cookie is a small amount of text that helps a website track information about a user across multiple pages of the website and personalize the user's experience on the website within the browser platform.

There is a present need in the art to transcend the functionality of traditional cookie functionality by providing a system and method to reach across platforms to not only provide user continuity across platforms but to engage and reinforce user engagement in context of data use across disjointed platforms.

### BRIEF DESCRIPTION OF THE DRAWINGS

FIG. 1 is a simplified diagram of a framework for providing continuity of user engagement across cross disconnected platforms, according to some embodiments.

FIG. 2 is a simplified diagram illustrating a computing device implementing the framework described in FIG. 1, according to some embodiments.

FIG. 3 is a simplified block diagram of a networked system suitable for implementing the framework described in FIG. 1 and other embodiments described herein.

FIG. 4 is an example logic flow diagram illustrating a method of continuity of user engagement across cross disconnected platforms, according to some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Existing web sites can generally track activities of users on the web site (e.g., monitoring and tracking a user's browsing activity during a session on the web site). For example, a web site can use cookies (e.g., in pixel logs, in which cookies are used to identify a user, at least anonymously, per device, and in which the cookies are typically persistent on the device, that is, the cookies are stored across sessions) or other approaches to track a user's activity on the web site. Thus, what is being actively browsed, viewed, and/or other user activities on the web site can be tracked. But if the user is anonymously accessing (e.g., browsing) the web site (e.g., if the user has not logged into/signed into the web site and/or has not otherwise verified the user's identity with the web site using a type of user authorization/authentication, such as username, a username and password, biometric verification of a user, a token, or other schemes or combinations thereof), then the web site generally cannot associate such tracked user activities with a specific/confirmed user identity.

As web sites continue to develop new services and content for users, there is an increasing need to be able to identify users even if the user has not logged into the given web site and/or has not otherwise authenticated or verified the user's identity with the web site. Additionally, there are an emerging multiplicity of networks and platforms including but not limited to location-based kiosks, in vehicle head-ends, local time domain networks, augmented reality platforms, peer-to-peer networks, virtual reality platforms, and digital twin platforms and others each created to deliver a more immersive, realistic, and engaging experience within their platform domains.

In one illustrative non-limiting example, there is a need for service providers to control the manner of presentation and/or to customize the content and/or understand a user's selections, preferences, or potential need of requisite services that are unique to the user. Customization and personalization with respect to interface, content, contextual use, historical data, affinity groupings, attribution of action and other aspects can lead to not only additional revenue for service providers but can also provide a better understanding of users needs in context. This greater understanding of users can allow providers to deliver a better and more relevant user experience.

The approach in the current art is for web service providers to challenge users to establish accounts which can be used to identify them and increasingly two factor authentication is a method of providing a secondary link to users identification but these secondary links are limited and can't be used to correlate data with user unless the user manually connects the disparate user profiles, thus limiting web service providers use of this data to personalize the content and form of their services (e.g., through dynamic web site implementations that can customize content delivered to users based on such user profiles).

To identify users, web service providers have traditionally relied on the user's signing or logging into the web site in order to access the web site. Sign-in/log-in based authorization on its own is generally very restrictive in that it will often only identify a fraction of users to a web site (e.g., as further discussed below, due to the fact that many users opt to browse a web site without signing/logging into that web site, such as for users that have not created sign-in credentials on that site, and this also often occurs in cases in which such users have sign-in credentials for that site, but elect not to sign-in due to user convenience or other reasons). Specifically, the sign-in (e.g., also referred to as log-in) based authorization approach applied by web service providers generally does not provide sufficient user-related data for at least the following reasons.

First, users can visit web sites anonymously. In particular, users often visit web sites anonymously, that is, without signing-in. As a result, it is difficult for such web sites to identify these users. Although this problem is not limited to any particular device type (e.g., desktop, laptop, tablet, phablet, smart phone, or another device type), it is generally a more prevalent issue for users browsing web sites on their mobile devices (e.g., tablets, phablets, smart phones or other types of mobile phones, and other types of mobile devices).

Second, users can have more than one device. With the proliferation of Internet connected devices, a single user may use many devices (e.g., tablet, home computer/laptop, work computer/laptop, mobile phone, smart TV, and/or other devices). As a result, users may browse content and, thus, create data for a user profile across such devices. However, this information can be valuable in generating a complete profile of the user.

Third, users now can access data across a plurality of platforms which may traverse multiple disparate networks as well as an array of very different local resources. The plurality of platforms and networks may include but should not limited to location-based kiosks, in vehicle head-ends, local time domain networks, augmented reality platforms, peer-to-peer networks, virtual reality platforms, and digital twin platforms and others each created to deliver a more immersive, realistic, and engaging experience within their platform domains.

Specifically, the combination of these three problems means that without a user sign-in on each device, a service provider will not be able to determine that the user behind the multiple devices operating on independent platforms or networks is the same user, as well as the continuity of interactions between the user and service providers.

More specifically, an inability to identify, understand and provide continuity to users creates several different problems for the service provider. The inability to be able to identify users makes it difficult for the service provider to personalize or customize the services for each user. For example, the service provider cannot effectively provide customized content for the user if the service provider cannot identify the user across devices (e.g., user platform). Furthermore, the site provider cannot connect user activity across devices to create user profiles. As a result, a typical approach is for service providers to simply attribute actions to devices instead of users (e.g., users that can be associated with two or more devices). For many service providers, these user profiles will continue to be split across devices if users are not signed in on each device that they use to access the service (e.g., to access the service provider's content).

Further, web services providing online content (e.g., dynamic or other customized content for a service) can be customized to provide different content to different users. However, as discussed above, customizing service content based on users in the state of the art is not effective if the user cannot be identified (e.g., a user that did not log into the web service), and the user accesses the web service from the multiplicity of devices, platform and networks available to them.

Thus, what are needed are systems and methods for identifying users of a service portal even if the user has not signed into the platform, including for users that access such platforms from multiple different devices/user platforms. Accordingly, techniques for cross platform user joining are disclosed.

In some embodiments, by using various signals, such as Internet Protocol (IP) addresses, in joining users across platforms, this system and method offers increased coverage of joined users and more complete user profiles (e.g., provides additional information by associating two or more, in some cases, anonymous user profiles). In particular, this technique does not rely solely on sign-in authentication to identify a user (e.g., in some cases, the exact user is not identified, but an anonymous user profile across platforms can be created using various systems and methods described below, and as further discussed below, in some cases one or more anonymous user profiles can be joined with a user identified user profile using sign-in, user provided information, and/or other techniques). In some embodiments, cross platform user joining includes associating a first user identification (UID) and a second UID with one or more Uniform Resource Locator (URL); associating the first UID's known location and a quick-response code (QR mark) with an indexed URL which fetches location and device resource information sending said information to a co-location index, forwards via said URL to a common app download resource. The cross-platform system and method also records one or more wireless identifiers created as a mobile device emits hundreds of short-range wireless signals per second, resulting in an anonymized “fingerprint” of a device in the immediate location.

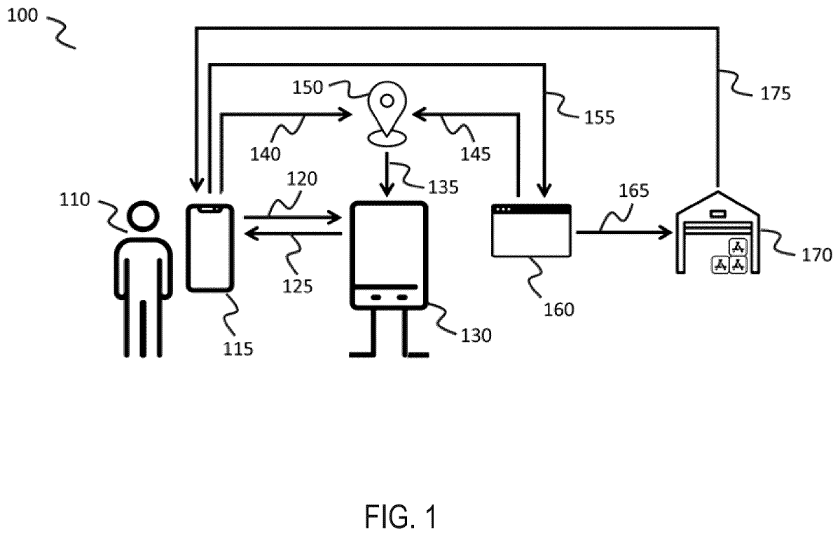

FIG. 1 is a simplified diagram of a framework 100 for providing continuity of user engagement across cross disconnected platforms, according to some embodiments. In some embodiments, a system is initiated by recognition of a user device 115 by proximity data 120 by a fixed location device 130 where proximity data 120 selected from the list Near Field Communication (NFC), Bluetooth, Bluetooth Low Energy (BLE), Wi-Fi, Ultra-Wideband (UWB), Global Positioning Systems (GPS), Differential Global Positioning Systems (DGPS), Magnetic Global Positioning Systems (MGPS), Long Wave Infrared (LWIR), Infrared, wireless, or optical recognition of an unknown device is detected. When recognition of said user device is found to index to an unknown user account initiates provision of a network link 125 which can be transmitted via a scannable mark, Near Field Communication (NFC), Bluetooth, Bluetooth Low Energy (BLE), Wi-Fi, Ultra-Wideband (UWB), or another peer-to-peer network.

Transfer of said link 125 representing a network location allows for a pointing of the default browser 155 of the user device 115 to a URL 160 which indexes the device request, fetches the device location and fingerprint data 145 before forwarding 165 the link to a common data warehouse 170 where apps are stored for unsigned download 175. Access of the downloaded app triggers a registry of the device unique identifiers 140 selected from any one or combination of device model, device number, network address, operating system, screen size, screen resolution. flash data. user-agent. system language and system country. device orientation, device location, battery level, installed fonts and installed plugins.

This system and method allows for activation of said app downloaded from said common resource indexed with the UID or more monitored behaviors; and joining the data 145 and the data 140 based on the one or more IPs and the one or more monitored behaviors. Joined data 150 may be communicated 135 to a device, e.g., fixed location device 130. Fixed location device 130 may display content specific to user 110 based on the received information.

For example, data 145 can be associated with a first set of monitored behaviors, and admittance data 134 can be associated with a second set of monitored behaviors 160. Also, data 145 can be associated with a first user platform 160, and data 140 can be associated with a second user platform. In some instances, data 145 can be associated with the first device, and the data 140 can be associated with a second mobile device, and at least one of the data 145 and the data 140 can correspond to an anonymous UID.

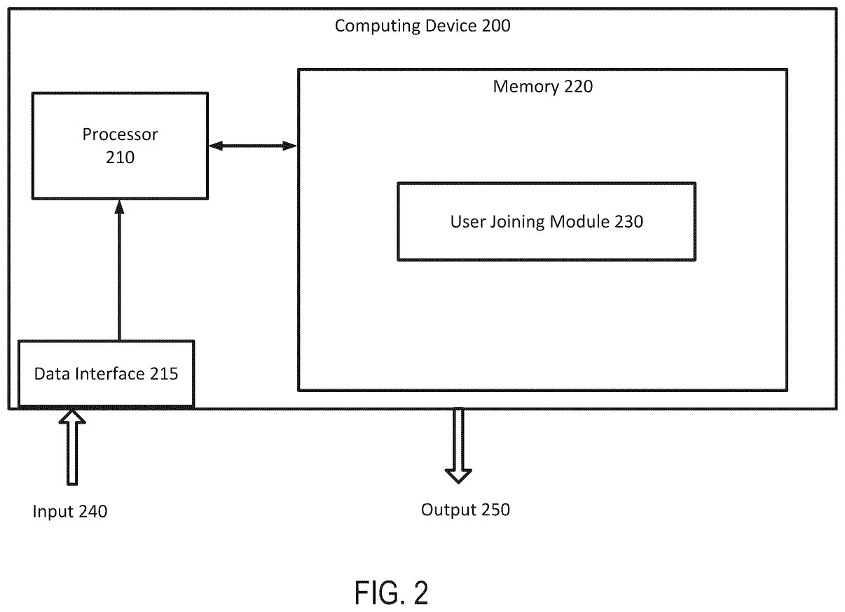

FIG. 2 is a simplified diagram illustrating a computing device 200 implementing the framework described in FIG. 1, according to some embodiments. For example, computing device 200 may be a user device 115 and/or a fixed location device 130. As shown in FIG. 2, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for user joining module 230 that may be used to implement and/or emulate the systems and models, and/or to implement any of the methods described further herein. User joining module 230 may receive input 240 such as app downloads, network link information, URLs, etc. via the data interface 215 and generate an output 250 which may be a UID, a URL, etc.

The data interface 215 may comprise a communication interface, a user interface (such as a voice input interface, a graphical user interface, and/or the like). For example, the computing device 200 may receive the input 240 from a networked database via a communication interface. Or the computing device 200 may receive the input 240 from a user via the user interface.

Some examples of computing devices, such as computing device 200 may include non-transitory, tangible, machine readable media that include executable code that when run by one or more processors (e.g., processor 210) may cause the one or more processors to perform the processes of methods described herein. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

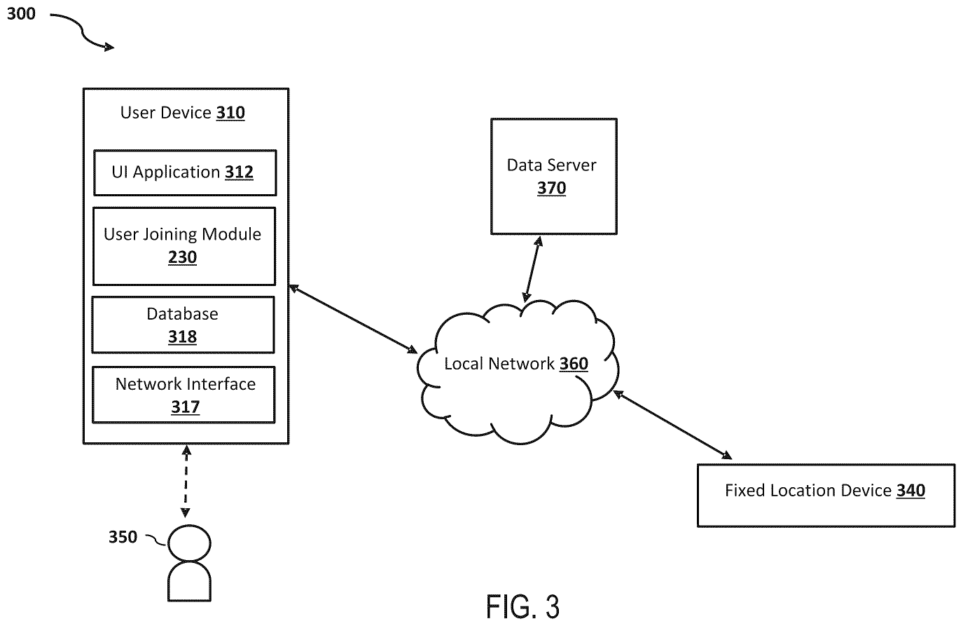

FIG. 3 is a simplified block diagram of a networked system 300 suitable for implementing the system described in FIG. 1 and other embodiments described herein. In one embodiment, system 300 includes the user device 310 (e.g., user device 115 in FIG. 1) which may be operated by user 350 (e.g., user 110 in FIG. 1), data server 370 (e.g., data warehouse 170 in FIG. 1), fixed location device 340 (e.g., fixed location device 130 in FIG. 1), and other forms of devices, servers, and/or software components that operate to perform various methodologies in accordance with the described embodiments. Exemplary devices and servers may include device, stand-alone, and enterprise-class servers which may be similar to the computing device 200 described in FIG. 2, operating an OS such as a MICROSOFT® OS, a UNIX® OS, a LINUX® OS, or other suitable device and/or server-based OS. It can be appreciated that the devices and/or servers illustrated in FIG. 3 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

User device 310, data server 370, and fixed location device 340 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

User device 310 may be implemented as a communication device that may utilize appropriate hardware and software configured for wired and/or wireless communication with data server 370 and/or the fixed location device 340. For example, in one embodiment, user device 310 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 310 of FIG. 3 contains a user interface (UI) application 312 which may correspond to executable processes, procedures, and/or applications with associated hardware. For example, the user device 310 may display a website or other user interface and the interface may modify based on embodiments described herein.

In various embodiments, user device 310 includes other applications as may be desired in particular embodiments to provide features to user device 310. For example, other applications may include security applications for implementing client-side security features, programmatic client applications for interfacing with appropriate application programming interfaces (APIs) over local network 360, or other types of applications. Other applications may also include communication applications, such as email, texting, voice, social networking, and IM applications that allow a user to send and receive emails, calls, texts, and other notifications through local network 360.

Local network 360 may be a network which is internal to an organization, such that information may be contained within secure boundaries. In some embodiments, local network 360 may be a wide area network such as the internet. In some embodiments, local network 360 may be comprised of direct connections between the devices. In some embodiments, local network 360 may represent communication between different portions of a single device (e.g., a network bus on a motherboard of a computation device).

Local network 360 may be implemented as a single network or a combination of multiple networks. For example, in various embodiments, local network 360 may include the Internet or one or more intranets, landline networks, wireless networks, and/or other appropriate types of networks. Thus, local network 360 may correspond to small scale communication networks, such as a private or local area network, or a larger scale network, such as a wide area network or the Internet, accessible by the various components of system 300.

User device 310 may further include database 318 stored in a transitory and/or non-transitory memory of user device 310, which may store various applications and data (e.g., model parameters, audio data, etc.) and be utilized during execution of various modules of user device 310. Database 318 may store text, audio, style preferences, etc. In some embodiments, database 318 may be local to user device 310. However, in other embodiments, database 318 may be external to user device 310 and accessible by user device 310, including cloud storage systems and/or databases that are accessible over local network 360.

User device 310 may include at least one network interface component 317 adapted to communicate with data server 370 and/or fixed location device 340. In various embodiments, network interface component 317 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data Server 370 may perform some of the functions described herein. For example, data server 370 may store information as a data warehouse as described with respect to data warehouse 170 of FIG. 1.

Fixed location device 340 may, in some embodiments, receive data from user device 310 or data server 370 via the network 360 to generate customer correlations. The generated customer correlations may also be sent to another device for review by a user, for example a store employee.

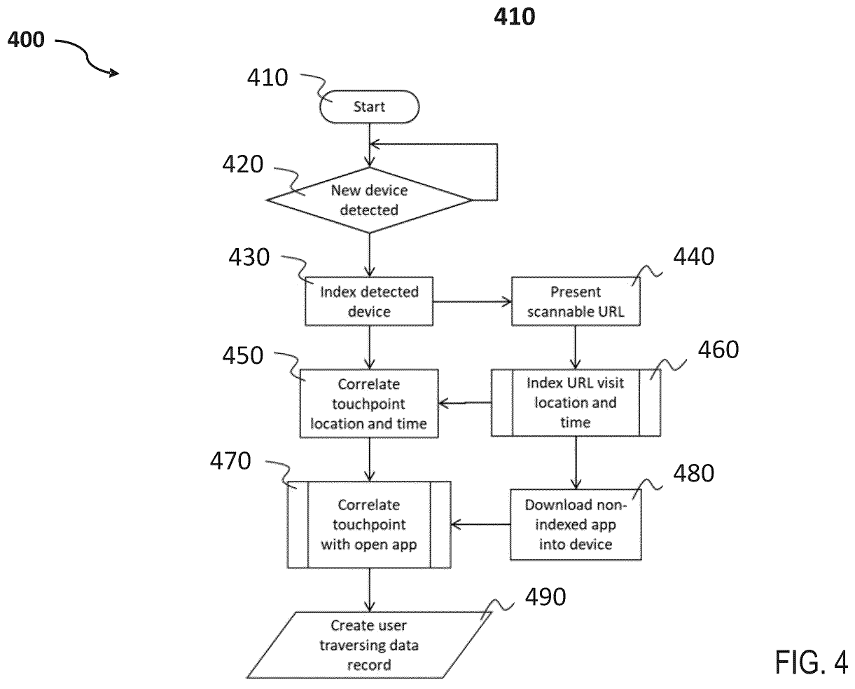

FIG. 4 is an example logic flow diagram illustrating a method 400 of continuity of user engagement across cross disconnected platforms, according to some embodiments. One or more of the processes of method 400 may be implemented, at least in part, in the form of executable code stored on non-transitory, tangible, machine-readable media that when run by one or more processors may cause the one or more processors to perform one or more of the processes. In some embodiments, method 400 corresponds to the operation of the user joining module 230 (e.g., FIGS. 2 and 3)

As illustrated, the method 400 includes a number of enumerated steps, but aspects of the method 400 may include additional steps before, after, and in between the enumerated steps. In some aspects, one or more of the enumerated steps may be omitted or performed in a different order.

In some embodiments, method 400 is initiated at start 410 by recognizing a user device through proximity data provided by a fixed location device 420. The proximity data can be selected from options such as Near Field Communication (NFC), Bluetooth, Bluetooth Low Energy (BLE), Wi-Fi, Ultra-Wideband (UWB), Global Positioning Systems (GPS), Differential Global Positioning Systems (DGPS), Magnetic Global Positioning Systems (MGPS), Long Wave Infrared (LWIR), Infrared, wireless, or optical recognition of an unknown device. Detection of an unknown device triggers the initiation of a network link 125, which can be transmitted through a scannable mark, Near Field Communication (NFC), Bluetooth, Bluetooth Low Energy (BLE), Wi-Fi, Ultra-Wideband (UWB), or another peer-to-peer network.

The unknown device is detected and indexed 430 which triggers presentation of a transfer link 440, representing a network location which is correlated to the point of link presentation 450 and directs the default browser of the user device to a URL 460. This URL indexes the device request, fetches the device location and fingerprint data 460, and forwards the link to a common data warehouse 480 where apps are stored for unsigned download 470. Accessing the downloaded app triggers the registration of device unique identifiers 490.

The linking of accounts per the system and method disclosed targets user experience, specifically as a method of consistent branding. This system and method enables continuity across diverse platforms, providing a method of unified branding and design. Users benefit from a cohesive and easily recognizable experience, irrespective of the device or platform they are using. This method not only strengthens brand identity but also creates a seamless and visually cohesive encounter for users.

Another significant benefit of this system and method is seamless handoff, which enables users to fluidly transition between platforms or devices without any interruption. This use of an indexed location linked user and device identity allows users to pick up exactly where they left off, contributing to a more convenient and user-friendly experience. The absence of disruptions effected by this system and method enhances user satisfaction and ensures a smooth flow of interactions across various devices.

This system and method synchronizes data, ensuring that user data, preferences, and progress are harmonized across platforms. This eliminates the need for users to duplicate efforts or re-enter information, saving time and effort. The seamless integration of data enhances user efficiency and provides a streamlined experience.

This system and method maintains user interaction independent of platform or device delivering personalization across devices, offering users consistent personalization. User preferences and personalized settings remain uniform across platforms, contributing to a more tailored and user-centric experience. This consistency ensures that users encounter familiar and personalized interfaces, irrespective of the device they are using.

This system and method disclosed additionally deliver consistent messaging, especially in multi-channel marketing and communication efforts. Continuity enabled by the ensures that the message and overall user experience remain consistent across various platforms, bolstering brand communication. This unified messaging strategy strengthens brand identity and fosters a cohesive brand perception among users.

This system and method uniquely enables cross-platform collaboration, leading to reduced user drop-offs. This system and method minimizes the likelihood of users abandoning interactions. This reduction in user drop-offs contributes to higher user retention rates, a key metric for the success of any digital platform.

This system and method enables adaptability to user context, allowing businesses to create an integrated customer journey. Continuity contributes to a more integrated customer journey, enabling businesses to design a seamless path from awareness to conversion across various touchpoints. This adaptability enhances the overall user experience and positively impacts customer engagement.

Another benefit of the system and method disclosed is unification of analytics, facilitating the gathering of comprehensive analytics and insights across platforms. This unified approach provides businesses with a holistic view of user behavior and preferences. Analyzing this data aids in making informed decisions, optimizing user experiences, and tailoring services to better meet user needs.

The devices described above may be implemented by one or more hardware components, software components, and/or a combination of the hardware components and the software components. For example, the device and the components described in the exemplary embodiments may be implemented, for example, using one or more general purpose computers or special purpose computers such as a processor, a controller, an arithmetic logic unit (ALU), a digital signal processor, a microcomputer, a field programmable gate array (FPGA), a programmable logic unit (PLU), a microprocessor, or any other device which executes or responds instructions. The processing device may perform an operating system (OS) and one or more software applications which are performed on the operating system. Further, the processing device may access, store, manipulate, process, and generate data in response to the execution of the software. For ease of understanding, it may be described that a single processing device is used, but those skilled in the art may understand that the processing device includes a plurality of processing elements and/or a plurality of types of the processing element. For example, the processing device may include a plurality of processors or include one processor and one controller. Further, another processing configuration such as a parallel processor may be implemented.

The software may include a computer program, a code, an instruction, or a combination of one or more of them, which configure the processing device to be operated as desired or independently or collectively command the processing device. The software and/or data may be interpreted by a processing device or embodied in any tangible machines, components, physical devices, computer storage media, or devices to provide an instruction or data to the processing device. The software may be distributed on a computer system connected through a network to be stored or executed in a distributed manner The software and data may be stored in one or more computer readable recording media.

The method according to the exemplary embodiment may be implemented as a program instruction which may be executed by various computers to be recorded in a computer readable medium. At this time, the medium may continuously store a computer executable program or temporarily store it to execute or download the program. Further, the medium may be various recording means or storage means to which a single or a plurality of hardware is coupled and the medium is not limited to a medium which is directly connected to any computer system, but may be distributed on the network. Examples of the medium may include magnetic media such as hard disk, floppy disks and magnetic tapes, optical media such as CD-ROMs and DVDs, magneto-optical media such as optical disks, and ROMs, RAMS, and flash memories to be specifically configured to store program instructions. Further, an example of another medium may include a recording medium or a storage medium which is managed by an app store which distributes application, a site and servers which supply or distribute various software, or the like.

Although the exemplary embodiments have been described above by a limited embodiment and the drawings, various modifications and changes can be made from the above description by those skilled in the art. For example, even when the above-described techniques are performed by different order from the described method and/or components such as systems, structures, devices, or circuits described above are coupled or combined in a different manner from the described method or replaced or substituted with other components or equivalents, the appropriate results can be achieved. It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method for ensuring continuity of user data, experience, and engagement across cross-disconnected platforms, comprising:
associating a first user identification and location data with at least one browser-born index;
relating a first data set, including indexed location data and one or more monitored behaviors, with the forwarding of a link to download a publicly available application;
joining the user data set and the data based on the one or more indexing and one or more monitored behaviors, the joining comprising:
determining whether a first user platform associated with the user data set sent the user an email containing a link for a product to purchase later, and a second user platform associated with a second user identification opened, from the email, the link containing the product to purchase later, the link including a unique identifier or a code specific to the user, and
in the event that the first user platform associated with the first user identification emailed the user the email containing the link for the product to purchase later, and the second user platform associated with the second user identification opened, from the email, the link containing the product to purchase later, joining the first and second user identifications;
generating a joined user profile based on the data and the second user identification; and
sending the joined user profile to a web service, wherein the web service can customize content presented by the web service to the user based on the joined user profile.

2. The method of claim 1, wherein associating the first user identification and location data is performed at a physical ingress point which includes recognition of a user device through proximity data provided by a fixed location device, the proximity data selected from the group consisting of Near Field Communication (NFC), Bluetooth, Bluetooth Low Energy (BLE), Wi-Fi, Ultra-Wideband (UWB), Global Positioning Systems (GPS), Differential Global Positioning Systems (DGPS), Magnetic Global Positioning Systems (MGPS), Long Wave Infrared (LWIR), Infrared, wireless, or optical recognition of an unknown device.

3. The method of claim 1, wherein the link to download the publicly available application is associated with a common data warehouse where applications are stored for unsigned download.

4. A system for providing continuity of user data, experience, and engagement across cross-disconnected platforms, wherein the system is configured to:
recognize a user device through proximity data gathered by a fixed location device;
present a transfer link representing a network location correlated to a point of link presentation;
direct a default browser of the user device to a URL that indexes the device request, fetches the device location and user data;
forward the link to a common data warehouse where apps are stored for unsigned download;
access the downloaded app triggering a registration of device unique identifiers;
use a common user identifier to retain sessions in memory indexed to an array of user touchpoints; and
transfer sessions stored in memory to user recognize on any cross-network touchpoint.

5. The system of claim 4, wherein the proximity data gathering employs at least one of Near Field Communication (NFC), Bluetooth, Bluetooth Low Energy (BLE), Wi-Fi, Ultra-Wideband (UWB), Global Positioning Systems (GPS), Differential Global Positioning Systems (DGPS), Magnetic Global Positioning Systems (MGPS), Long Wave Infrared (LWIR), Infrared, wireless, or optical recognition of an unknown device.

6. The system of claim 4, further configured to join accounts based on one or more Internet Protocol (IP) addresses and one or more monitored behaviors.

7. The system of claim 4, further configured to index the downloaded app with one or more monitored behaviors and joining the data based on the one or more IPs and the one or more monitored behaviors.

8. The system of claim 4, wherein the device unique identifiers include at least one of device model, device number, network address, operating system, screen size, screen resolution, flash data, user-agent, system language, system country, device orientation, device location, battery level, installed fonts, or installed plugins.

9. A computer program product embodied on a non-volatile computer-readable storage medium, the computer program product comprising instructions that, when executed, cause a system to:
recognize a user device through proximity data gathered by a fixed location device;
present a transfer link representing a network location correlated to the point of link presentation;
direct a default browser of the user device to a URL that indexes the device request, fetches the device location and user data;
forward the link to a common data warehouse where apps are stored for unsigned download;
access the downloaded app triggering a registration of device unique identifiers;
use a common user identifier to retain sessions in memory indexed to an array of user touchpoints; and
transfer sessions stored in memory to user recognize on any cross-network touchpoint.

10. A system comprising one or more processors configured, alone or in any combination, to execute instructions stored on one or more memories coupled to the processor, wherein the instructions when executed by the one or more processors cause the system to:
recognize a user device through proximity data gathered by a fixed location device;
present a transfer link representing a network location correlated to the point of link presentation;
direct a default browser of the user device to a URL that indexes the device request, fetches the device location and user data;
forward the link to a common data warehouse where apps are stored for unsigned download;
access the downloaded app triggering a registration of device unique identifiers;
use a common user identifier to retain sessions in memory indexed to an array of user touchpoints; and
transfer sessions stored in memory to user recognize on any cross-network touchpoint.
